(19) United States
(12) Patent Application Publication
(10) Pub. No.: US 2018/0314602 A1
(43) Pub. Date: Nov. 1, 2018

(54) METHOD FOR REDUNDANCY OF A VLR DATABASE OF A VIRTUALIZED MSC

(71) Applicant: Telefonaktiebolaget LM Ericsson (publ), Stockholm (SE)

(72) Inventors: Oliver SPEKS, Eschweiler (DE); Timo HELIN, Herzogenrath (DE)

(21) Appl. No.: 15/756,104

(22) PCT Filed: Sep. 7, 2015
(86) PCT No.: PCT/EP2015/070354

§ 371 Date: Feb. 28, 2018

(51) Int. Cl. G06F 11/14; H04W 8/30

(52) U.S. Cl. CPC G06F 11/1464; G06F 11/1448; H04W 8/30; G06F 11/1484

(57) ABSTRACT

Network Entity, comprising a Database that keeps client related information stored for the duration of which the client is served by the Network Entity; a Shadow Database as a backup of the Database; a Shadow Cluster Database as a backup of the Shadow Database; a Storage Interface for communicating a change of the Shadow Cluster Database to an backup file of the Shadow Cluster Database; and a non-volatile storage for storing the backup file of the Shadow Cluster Database.

### TECHNICAL FIELD

The present invention relates to a Network Entity comprising a Database that keeps client related information, Execution Entities for deployment in this Network Entity, a method for handling client related information and a computer program product.

### BACKGROUND

A Mobile Switching Center node (MSC node) as a Network Entity is a node within a circuit switched core network of a mobile telephony network serving GSM (Global System for Mobile Communications), WCDMA (Wideband Code Division Multiple Access) and LTE (Long Term Evolution) subscribers roaming in the CS domain (Circuit-Switched Domain). The MSC node is primarily responsible for mobility management, routing and circuit control. Multiple MSC nodes can be arranged in a pooled configuration within the network. All of the pooled MSC nodes share control over the same radio network resources.

A MSC node has a co-located visitor location register (VLR) that keeps subscriber related information stored for the duration of which the subscriber is served by the particular MSC node. The majority of subscriber related information is fetched from a central home location register (HLR). Some information stored in the VLR has a volatile nature and is only stored in the VLR, without being available in the HLR. A loss of either kind of data leads to degradation of serviceability and should be avoided.

Information and telecommunication industry (ITC) trend is replacing applications executing on dedicated, purpose-built hardware with applications that executed on a virtualized environment within data centers on commercial off-the-shelf (COTS) hardware. Software that was previously executed on a physical board is now executed within a virtual machine that makes used of virtualized infrastructure provided by the data center. The infrastructure consists of compute, storage and networking. Architecture of virtualized data centers has been specified by ETSI ISG and can be taken from ETSI GS NFV 002. In this architecture the MSC is seen as virtualized network function (VNF) that is running on virtual machines deployed on compute hosts. Virtual machines can be re-allocated between compute hosts, which is referred to as migration. Migration types that require reboot of the guest operating system running within the virtual machine is called non-live migration. Re-instantiation of a virtual machine due to outage of the original compute host is referred to as evacuation.

State-of-the-art MSC/VLR system architectures store VLR data in RAM. It is assumed that the likelihood of disturbances is small enough to justify loss of the RAM based storage.

In an MSC node comprising a VLR, the VLR data can survive certain system recovery procedures. In a scalable blade cluster architecture, typically each VLR data record is stored on two CP blades so that no VLR data are lost in the event of a single blade failure. After recovery of a blade, redundancy is re-established when the respective subscriber is involved in a transaction. In enhanced solutions for MSC nodes comprising VLR a location area is stored in an external database or in a buddy MSC node comprising a VLR within the same MSC pool.

When content of a random access memory (RAM) gets lost in an MSC node comprising a VLR, e.g. due to power failure or system crashes, the entire VLR data set is lost. Although subscription related data can be retrieved from the HLR, this procedure has drawbacks and limitations, since retrieving of the subscriber record from a HLR prolongs the call set up and may lead to failed call set up due to expiration of supervision timers on the radio side. In addition the retrieval of subscriber records for a large amount of subscribers within short time will exhaust the capacity of HLR and consequently originating and terminating transactions will be rejected by the MSC for affected subscribers. A Temporary Mobile Subscriber Identity (TMSI) cannot be retrieved from HLR. When the User Entity (UE) identifies itself by means of the TMSI, it will be rejected as unknown and has to perform a location update exposing the International Mobile Subscriber Identity (IMSI) on the radio interface. The first mobile originating call set up will fail and privacy of the user is compromised. The MSC will allocate a new TMSI to the UE.

Location area and serving Mobility Management Entity address (MME address) of the UE cannot be retrieved from HLR. The only way to reach a subscriber with unknown location for terminating transaction, e.g. mobile terminating call or mobile terminating SMS, is to perform paging within the entire area serviced by the MSC, i.e. global paging. The radio network has only limited capacity for global paging and global paging is not enabled in all networks. Without global paging, affected subscribers are not reachable until the UE performs periodic location update or the user attempts an originating call or initiates a different transaction.

An MSC Blade Cluster Server can store VLR data on two blades, i.e. the blade that serves the subscriber and a buddy blade. If one of these blades loses the RAM contents, then 1:1 redundancy needs to be re-established after recovery of the failed blade or after subscriber re-allocation amongst the remaining blades. If the buddy blade loses RAM contents as well, before data redundancy was re-established, then the VLR data set is lost in the MSC node. With native deployment, this could happen only at double hardware fault. Mean time to failure of telecom grade hardware spans typically several decades. In virtualized deployment the mean time to failure of a VM is expected to be much shorter.

Problems that this invention is addressing are originating from two aspects, an organizational aspect and architectural aspect.

Operation and management of the virtualized network function is typically performed within what is referred to as “tenant administrative domain”, whereas operation and management of the virtualized infrastructure is performed within what is referred to as “infrastructure administrative domain”. The two administrative domains can not only be organizationally separated, but they can also be run by different companies. VNF specific knowledge or consideration cannot be expected from staff working within the infrastructure administrative domain.

The introduction of a virtualization layer increases the likelihood for planned and unplanned outages. Design objectives for virtualized compute infrastructure are different from objectives for virtualized storage infrastructure. A Virtualized Storage Infrastructure guarantees persistence of data, using technologies such as RAID to keep stored data redundant. Operational procedures for storage infrastructure maintenance consider preservation of stored data. However, a Virtualized Compute Infrastructure is unaware of application level data redundancy schemes. Any operation within the infrastructure administrative domain can therefore inadvertently interfere with, hamper or undermine application level data redundancy mechanisms.

To avoid computing hardware to become a single point of failure, it is possible to configure the cloud management system in a way that prevents 1:1 redundant virtual machines from being deployed on the same compute host. However, this will only prevent simultaneous outage of redundant application components for some scenarios. Even if it helps to make simultaneous disturbances of redundant virtual machines less likely, it does not in any way consider the need for restauration of data redundancy after recovery of a first virtual machine or after subscriber re-allocation before the other virtual machine used for data redundancy is exposed to disturbances.

During maintenance activities in a data center using virtualization technologies, especially during upgrade/update of firmware, host operating system or hypervisor, compute hosts are typically taken out of service one by one in batch mode. Guest virtual machines are migrated to other compute hosts. If non-live migration is used, the VM will be rebooted. Within the context of this invention, the most critical operational procedure is non-live migration of virtual machines between compute hosts.

When virtual machines are taken out of service, evacuated or non-live migrated to other compute hosts one by one, the VM gets rebooted and loses RAM-stored VLR data. Even if backup of VLR data is stored on other VMs, the VM that contains backup data may be subject to non-live migration and therefore loses the RAM stored data as well before redundancy is regained after booting of the first migrated VM. Batch mode non-live migration will therefore lead to VLR data loss, irrespective of existing RAM-based redundancy mechanisms.

In-service-performance of MSC deployed in virtualized data center is supposed to be on par with native deployment. System architecture needs to be adapted to compensate the increased risk for outages and the need for more operational procedures which would otherwise impact ISP of the MSCv (MSC virtualized).

### SUMMARY

It is an object of the present invention to reduce the risk of losing client related information stored in a database.

This object is solved by subject-matter according to the independent claims. Preferred embodiments are subject of the dependent claims, the description and the figures.

According to a first aspect this object is solved by a Network Entity, comprising a Database that keeps client related information stored for the duration of which the client is served by the Network Entity; a Shadow Database as a backup of the Database; a Shadow Cluster Database as a backup of the Shadow Database; a Storage Interface for communicating a change of the Shadow Cluster Database to an backup file of the Shadow Cluster Database; and a non-volatile storage for storing the backup file of the Shadow Cluster Database. The Network Entity can be applied both for native and virtualized data center deployment. A VLR data redundancy can be achieved by a node-internal in-memory database with backup on disk. The solution is optimized to keep the processing and internal communication load low during normal operation, allowing for real-time access to VLR data in recovery scenarios and keeping recovery times short.

An apparatus for a network entity comprising a processor and a memory is provided, said memory containing instructions executable by said processor whereby said apparatus is operative to keep client related information stored for the duration in a database of which the client is served by the Network Entity; provide a Shadow Database as a backup of the Database; provide a Shadow Cluster Database as a backup of the Shadow Database; provide a Storage Interface for communicating a change of the Shadow Cluster Database to an backup file of the Shadow Cluster Database; and store the backup file of the Shadow Cluster Database in a non-volatile storage.

In a preferred embodiment of the Network Entity the Database and the Shadow Database are provided by a first virtual machine or first blade unit and the Shadow Cluster Database and the Storage Interface are provided by a second virtual machine or second blade unit. This embodiment has the technical advantage that a hardware failure on the first blade or virtual machine does not affect the register on the second blade and vice versa and in case of outage of either one, data can still be served from an in-memory data base in real time.

In a further preferred embodiment of the Network Entity the non-volatile storage comprises a storage area network or a physical storage of high persistence. This embodiment is in line with virtualized data center architecture and has the advantage that cloud infrastructure design and operational procedures will make sure that stored backup file is not lost. The physical storage of high persistence can be a redundant array of independent disks or any other system which stores data in a more persistent manner as compared to a regular hard disk. This embodiment has the technical advantage that the risk of losing the backup file can be reduced.

In a further preferred embodiment of the Network Entity the database and the shadow database are combined in one database. This embodiment has the technical advantage that both databases can be handled more efficiently.

In a further preferred embodiment of the Network Entity the Shadow Database comprises a first table indexed on the basis of a client identity for storing information that is frequently updated and a second table indexed on the basis of a client identity for storing information that is less frequently updated. A client identity may comprise any non-temporary client identity, for example an International Mobile Subscriber Identity.

In a further preferred embodiment of the Network Entity the Shadow Database comprises a third table for storing mapping information between a temporary identity of mobile subscriber equipment and the International Mobile Subscriber Identity. The temporary identity of mobile subscriber equipment can be a temporary mobile subscriber identity TMSI, a Globally Unique Temporary Identity GUTI or a packet temporary mobile subscriber P-TMSI, which are used by a Mobile-services Switching Centre MSC, a Mobility Management Entity MME and a SGSN Serving GPRS Support Node, respectively. These embodiments have the technical advantage that the volume of data that is transferred during normal operation for backup purposes is kept to a minimum, thereby offloading the infrastructure of the datacenter and requiring less compute capacity.

In a further preferred embodiment at least one of the first, second, and third table comprises a cluster database fetcher associated to it for recovering the content of the respective table from the Shadow Cluster Database. This embodiment has the technical advantage that processing and data transfer is minimized during normal operation and data that is not available on the Shadow VLR can in real time be served from the in-memory database of the Shadow Cluster VLR.

In a further preferred embodiment of the Network Entity the Shadow Cluster Database comprises a first table indexed on the basis of client identity for storing information that is frequently updated, a second table indexed on the basis of a client identity for storing information that is less frequently updated.

In a further preferred embodiment of the Network Entity the Shadow Cluster Database comprises a third table for storing mapping information between the International Mobile Subscriber Identity and a temporary identity of mobile subscriber equipment. The temporary identity of mobile subscriber equipment can be for example a temporary mobile subscriber identity TMSI, a Globally Unique Temporary Identity GUTI or a packet temporary mobile subscriber P-TMSI, which are used by a Mobile-services Switching Centre MSC, a Mobility Management Entity MME and a SGSN Serving GPRS Support Node, respectively. These embodiments have also the technical advantage that data throughput for maintaining the backup data during normal operation is minimized and requests can be quickly served in real time form the in-memory database.

In a further preferred embodiment of the Network Entity at least one of the first, second, and third table comprises a Storage Fetcher associated to it for recovering the content of the respective table from the backup file. This embodiment has the technical advantage that the content of the table can be recovered fast and reliably and the Shadow Cluster VRL will have the database content fully available in-memory quickly after an outage and will be able to serve requests from the Shadow Blade-VLRs very fast.

In a further preferred embodiment of the Network Entity the information that is frequently updated comprises mobility related information and the information that is less frequently updated comprises subscription related information. The mobility related information can comprise information regarding a temporary identity of mobile subscriber equipment, a location information, a cell identification or a Mobility Management Entity identity. This embodiment has the technical advantage that a suitable separation of content to be stored in independent tables is achieved.

In a further preferred embodiment of the Network Entity the Database, the Shadow Database and the Shadow Cluster Database are stored in a memory. The memory can be for example a random access memory (RAM) or a Content Addressable Memory CAM. This embodiment has the technical advantage that a fast access to the registers is provided.

In a further preferred embodiment of the Network Entity the Network Entity comprises a Mobile Switching Center Node, a Serving General Packet Radio Service (GPRS) Support Node or a Mobility Management Entity. This embodiment has the technical advantage that digital cellular networks used by mobile phones can be provided with redundant client related information.

In a further preferred embodiment of the Network Entity the Shadow Cluster Database comprises a superset of a plurality of Shadow Databases. This embodiment has the technical advantage that a central register can be used to reduce the effort of storing a plurality of Shadow Databases and it allows restoration of Shadow Blade-VLR databases also when the number of blades or VMs has changed and subscribers have been re-allocated amongst them since writing to the Shadow Cluster VLR database contents. This approach allows to recover the data for subscribers from different VM/blades than the ones that were storing the data, which is relevant for fault or scaling scenarios where the number of blades changes between storing and recovery.

According to a second aspect this object is solved by an Execution Entity for deployment in a Network Entity, comprising an interface for communicating with a Database that keeps client related information stored for the duration of which the client is served by the Network Entity; a Shadow Database as a backup of the Database; and a Cluster Database Interface for communicating with a Shadow Cluster Database as a backup of the Shadow Database. This Execution Entity has the same technical advantages as the Network Entity according to the first aspect.

An apparatus for an Execution Entity for deployment in a Network Entity comprising a processor and a memory is provided, said memory containing instructions executable by said processor whereby said apparatus is operative to provide an interface for communicating with a Database that keeps client related information stored for the duration of which the client is served by the Network Entity; provide a Shadow Database as a backup of the Database; and provide a Cluster Database Interface for communicating with a Shadow Cluster Database as a backup of the Shadow Database.

According to a third aspect this object is solved by an Execution Entity for deployment in a Network Entity, comprising an interface for communicating with a Shadow Database; a Shadow Cluster Database as a backup of the Shadow Database; and a Storage Interface for communicating a change of the Shadow Cluster Database to a backup file of the Shadow Cluster Database. This Execution Entity has the same technical advantages as the Network Entity according to the first aspect.

An apparatus for an Execution Entity for deployment in a Network Entity comprising a processor and a memory is provided, said memory containing instructions executable by said processor whereby said apparatus is operative to provide an interface for communicating with a Shadow Database; provide a Shadow Cluster Database as a backup of the Shadow Database; and provide a Storage Interface for communicating a change of the Shadow Cluster Database to a backup file of the Shadow Cluster Database.

According to a fourth aspect this object is solved by an Execution Entity for deployment in a Network Entity, comprising a database that keeps client related information stored for the duration of which the client is served by the Network Entity; wherein the Database comprises a first table indexed on the basis of a client Identity for storing information that is frequently updated and a second table indexed on the basis of an client Identity for storing information that is less frequently updated.

An apparatus for an Execution Entity for deployment in a Network Entity comprising a processor and a memory is provided, said memory containing instructions executable by said processor, whereby said apparatus is operative to provide a database that keeps client related information stored for the duration of which the client is served by the Network Entity; wherein the Database comprises a first table indexed on the basis of a client Identity for storing information that is frequently updated and a second table indexed on the basis of an client Identity for storing information that is less frequently updated.

In a preferred embodiment of the Execution Entity the Execution Entity is a blade unit or a virtual machine. This embodiment has the technical advantage that fast and independent units are used.

According to a fifth aspect this object is solved by a method for handling client related information, comprising the steps of keeping client related information stored for the duration of which the client is served by a Network Entity in a Database; providing a Shadow Database as a backup of the Database; providing a Shadow Cluster Database as a backup of the Shadow Database; providing a Storage Interface for communicating a change of the Shadow Cluster Database to an backup file of the Shadow Cluster Database; and storing the backup file of the Shadow Cluster Database in a non-volatile storage. The method has the same technical advantages as the Network Entity according to the first aspect.

In a preferred embodiment of the method the backup file is stored on a physical storage of high persistence or on virtual storage provided by a storage area network. This embodiment has the technical advantage that the risk of losing the backup file can be reduced.

In a further preferred embodiment of the method the client related information of the Shadow Database or the Shadow Cluster Database is stored in a first table for storing information that is frequently updated, a second table for storing information that is less frequently updated, and a third table for storing mapping information. This embodiment also has the technical advantage that the amount of data that needs to be processed and transferred during normal operation is minimized.

In a further preferred embodiment of the method the Shadow Cluster Database is checked in regular intervals for table entries that have expired time stamps and table entries that have expired time stamps are removed from the corresponding table. This embodiment has the technical advantage that the need for storage space for storing the tables does not increase over time due to unused entries that are never removed.

In a further preferred embodiment of the method it is checked in regular intervals for inconsistencies between the corresponding tables. This embodiment has the technical advantage that errors resulting from inconsistencies can be detected.

According to a sixth aspect this object is solved by a computer program product directly loadable into the internal memory of a digital computer, comprising software code portions for performing the steps according to the method according to the fourth aspect when said product is run on a computer. The computer program product has the same technical advantages as the method according to the fifth aspect.

### BRIEF DESCRIPTION OF THE DRAWINGS

Further embodiments may be described with respect to the following Figures, in which:

FIG. 1 shows a set of VMs or Blades, which are executing traffic handling of an MSC;

FIG. 2 shows a configuration of a Shadow Visitor Location Register;

FIG. 3 shows a configuration of a Shadow Cluster Visitor Location Register;

FIG. 4 shows backup files of a Shadow Cluster Visitor Location Register;

FIG. 5 shows an activity flow of a Garbage Collector; and

FIG. 6 shows a block diagram of a method for handling subscriber related information; and

FIG. 7 shows a computer as Network Entity.

### DETAILED DESCRIPTION OF EMBODIMENTS

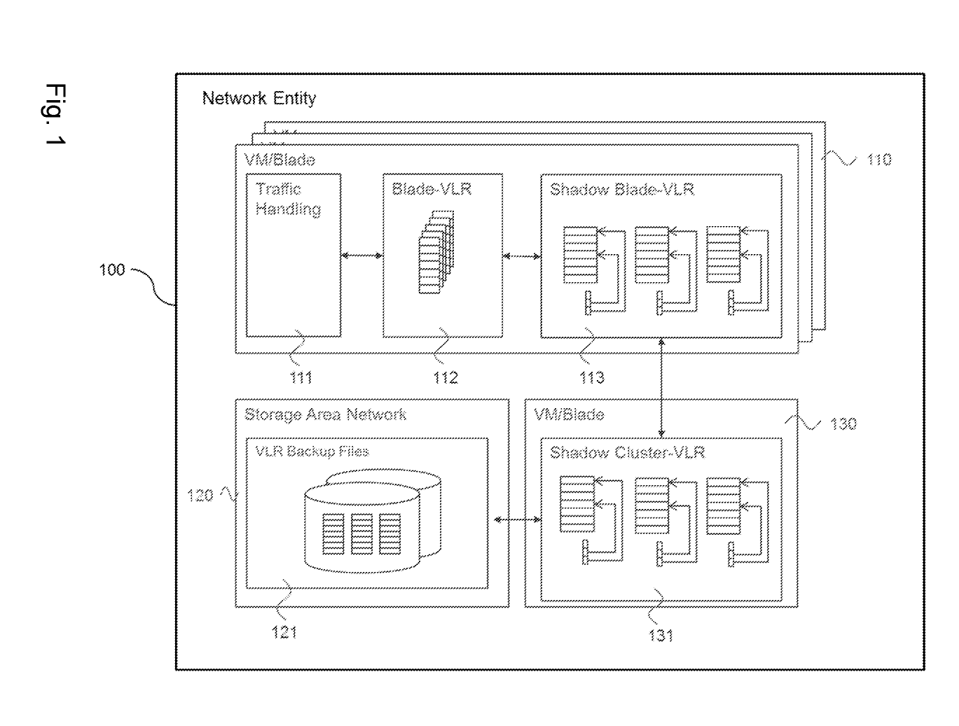

FIG. 1 shows a set of virtual machines (VMs) or blades 110 as execution entities, which are executing traffic handling 111 of an MSC node 100 as Network Entity. Subscription data and other information that is needed to process traffic for the subscribers served by the VMs/blades 110 are stored in a Visitor Location Register 112, which may be distributed in the implementation over several objects, tables or registers. The subscription data comprise client related information.

To the aforementioned elements on the VM/Blade 110 a Shadow Visitor Location Register 113 is added as component that stores VLR data and handles redundancy and recovery aspects of VLR data. The Shadow Visitor Location Register 113 serves as a backup of the Visitor Location Register 112. The Shadow VLR 113, which can be present on every VM/Blade 110 that performs traffic handling, communicates with a further Shadow Cluster-VLR 131 allocated on a separate VM/Blade 130.

The Shadow VLR 113 and the Shadow Cluster-VLR 131 store VLR data of all subscribers served by the MSC node 100 in a RAM-based database. The Shadow Cluster Visitor Location Register 131 serves as a backup of the Shadow Visitor Location Register 113 and can serve as a backup for multiple Shadow VLRs 113 located on different entities.

The Shadow Cluster-VLR 131 controls a set of backup files 121 located within a storage area network 120 as a non-volatile storage. The storage area network 120 is provided with redundancy guarantees, i.e. storage can be considered to be lossless even in power failure or hardware failure situations, e.g. hard disk crash.

In summary, VLR data is kept within the MSC node 100 with triple redundancy, where the first two stages keep the data base in RAM and last stage is robust against any type of outage including power failures or mechanical failures of individual components.

A virtual machine is an emulation of a particular computer system. Virtual machines operate based on the computer architecture and functions of a real or hypothetical computer and their implementations may involve specialized hardware, software, or a combination of both. A blade is a server computer with a modular design optimized to minimize the use of physical space and energy.

The Network Entity 100 is for example a Mobile Switching Center Node, a Serving GPRS Support Node (part of 2G and 3G packet switched networks) or a Mobility Management Entity (part of 4G network) for handling traffic in digital cellular networks used by mobile phones, like the Global System for Mobile Communications (GSM). In general the Network Entity can be every physical or virtual unit that is capable of providing the corresponding functions for managing mobility of user equipment. The Network Entity can be provided on a single node or in a distributed manner across a cloud comprising several computers.

Accordingly, the Execution Entity is for example a blade unit 110 of a blade server or a virtual machine 110 in a server. In general the Execution Entity can be every physical or virtual unit that is capable of executing the corresponding functions. The Execution Entity is a part of the Network Entity and can be located on a single node or in a distributed manner across a cloud.

The registers are databases with an organized collection of data for the subscription data and other information that is needed to process traffic for clients served, like subscribers of mobile phones in digital cellular networks. The registers can be provided by databases that are stored in random access memory. The database can be accessed by corresponding interfaces.

When deployed on native infrastructure, traffic handling within the MSC node 100 as Network Entity can be performed by one or more blades. When deployed in a virtualized data center, traffic handling within the MSC node may 100 be shared by multiple virtual machines. For efficiency reasons, load sharing between blades or VMs is most suitable done on per subscriber basis so that VLR data as well as transaction related data for a given subscriber does not need to be shared amongst blades or VMs. Small systems that do not share processing load amongst n blades or VMs with n>1 can be considered as a special case of n=1. The subject-matter still applies for this special case.

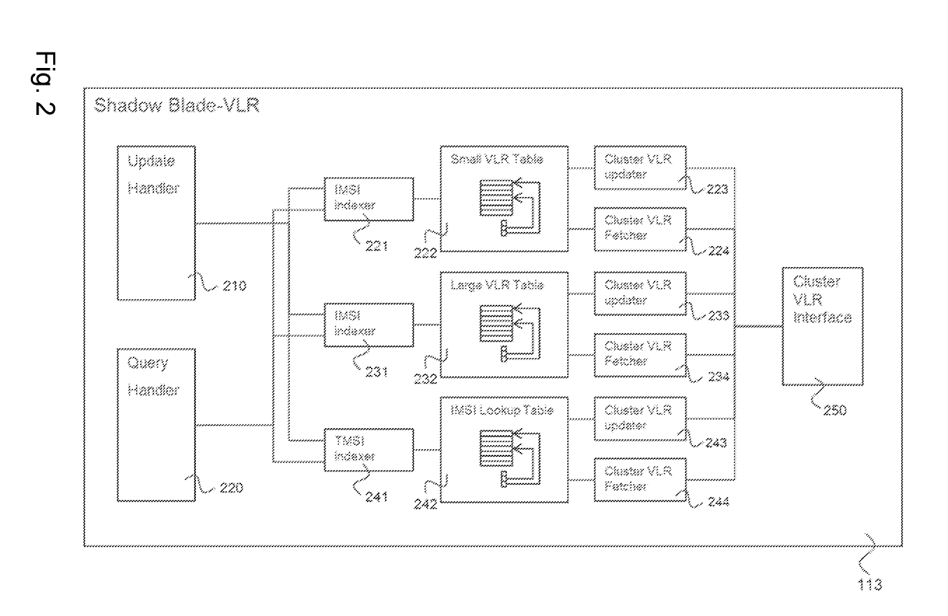

FIG. 2 shows a configuration of a Shadow Visitor Location Register 113. The Shadow VLR 113 has three external interfaces. Towards the Blade VLR 112 it communicates by a Query Handler 220 and Update Handler 210 as interfaces. Towards the Shadow Cluster-VLR 131 it communicates through the Cluster VLR Interface 250.

VLR data is stored in three tables within the Shadow-VLR 113. The VLR table 222 stores information that is frequently updated, such as a Temporary Mobile Subscriber Identity TMSI, location information, a cell identification or a MME identity. A further VLR Table 232 stores information that is less frequently updated, like subscription related information. An IMSI lookup table 242 stores mapping information and allows translating a TMSI to an IMSI.

Any change in the blade VLR 112 is pushed through an Update Handler 210 to the table that stores the respective type of information. Within the VLR tables 222 and 232 the position of the table entry is determined by hashing on IMSI. Within the IMSI lookup table 242 the position of the table entry is determined by hashing on TMSI. The IMSI indexer 221, 231 and 241 find the position of entries within the corresponding tables.

Each table has a Cluster VLR updater 223, 233, 243 associated to it. Whenever a table entry is modified, added or deleted, the Cluster VLR updater 223, 233, 243 pushes the changed data through the Cluster VLR Interface 250 to the Shadow Cluster-VLR 131. This data pushing is done asynchronously to the table change, so that no latency is added to real-time traffic handling. A queuing mechanism can be implemented, for example as linked list. The entry of VLR table 222 is provided with a timestamp indicating the last radio contact with the mobile station.

Each table has a Cluster VLR fetcher 224, 234 and 244 associated to it. Whenever a query is received for a table entry that does not exist, the request is passed by the Cluster VLR fetcher 224, 234 and 244 through the Cluster-VLR Interface 250 to the Shadow Cluster-VLR 131 and the data is retrieved from there. Tables can be implemented by corresponding databases. One or more tables of the databases or one or more databases can be combined in a single common database.

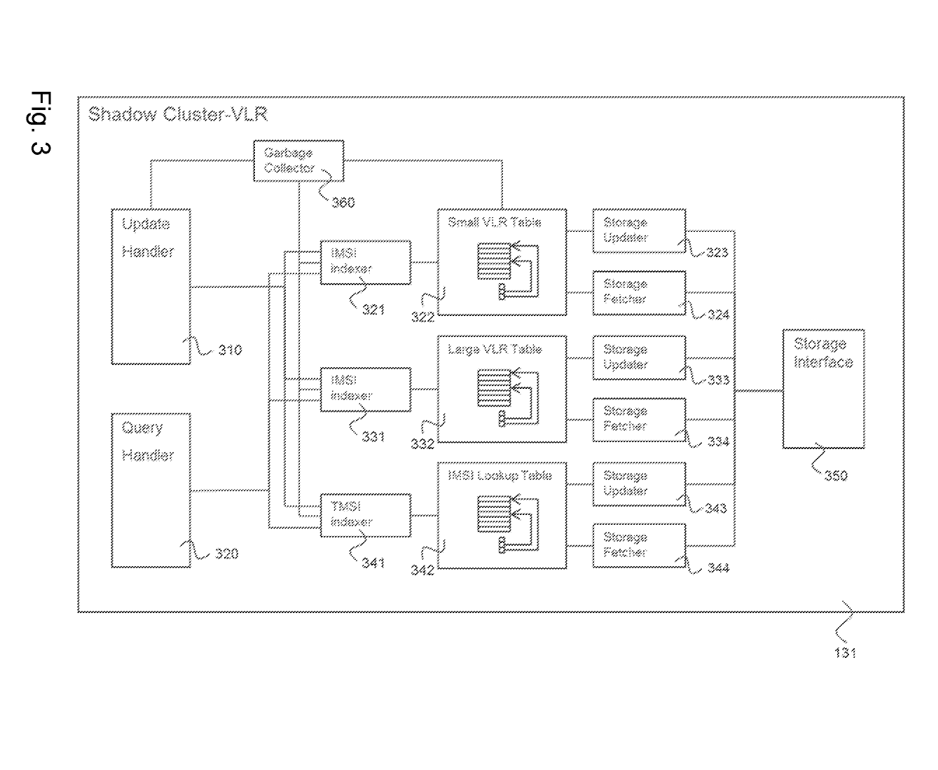

FIG. 3 shows a configuration of a Shadow Cluster Visitor Location Register 131. The Shadow Cluster-VLR 131 has three external interfaces. Towards the Shadow Blade VLR 113 it communicates by Update Handler 310 and Query Handler 320 as interfaces. Towards the Storage Area Network 210 it communicates through the Storage Interface 350. Other than shown in FIG. 3, the tables and their associated components can also be allocated to multiple blades/VMs 110.

VLR data is stored in three tables within the Shadow Cluster-VLR 131. The VLR Table 322 stores information that is frequently updated, such as a TMSI, location information, a cell identification or a MME identity. The VLR Table 332 stores information that is less frequently updated, like subscription related information. The IMSI lookup table 342 stores mapping information and allows translating a TMSI to an IMSI. The table structure is the same as for the Shadow VLR 113, but the Shadow Cluster-VLR 131 stores the superset of all VLR data.

Any change on a blade VLR 113 is pushed through the Update Handler 310 to the table that stores the respective type of information. Within the VLR tables 322 and 332 the position of the table entry is determined by hashing on IMSI. Within the IMSI lookup table 342 the position of the table entry is determined by hashing on TMSI. Tables can be implemented by corresponding databases.

Each table has a Storage Updater 323, 333, 343 associated to it. Whenever a table entry is modified, added or deleted, the Storage Updater 323, 333, 343 pushes the changed data through the Storage Interface 350 to a set of files on hard disk 121. This data pushing is done asynchronously to the table change. A queuing mechanism can be implemented, for example as linked list.

Each table has a Storage Fetcher 324, 334, 344 associated to it. When the table content gets lost due to outage of the VM/Blade 130 that hosts the Shadow Cluster-VLR 131, it recovers the entire table from the respective file 411, 412 or 413 stored on disk 121.

The VLR table 322 has additionally a Garbage Collector 324 associated to it. Should a subscriber deregistration be missed due to outage of the respective traffic handling blade/VM 110, then a stale entry in the tables on the Cluster-VLR 131 and the mirror on disk will remain. Such entries can be identified and eliminated by the Garbage Collector. The Garbage Collector deletes all table entries that are older than a certain threshold limit. The age of entries related to a subscriber can be determined by the associated timestamp within the VLR table 322.

The threshold age should be larger than the duration of automatic deregistration which is configured in the MSC node 100. Automatic deregistration removes a subscriber from VLR when periodic location update was not performed in time. The timestamp is received along with the payload from the VLR 113. Furthermore, the Garbage Collector detects inconsistencies between the tables that can be the result of outages of the Shadow Cluster-VLR 131. It does so by marking related records in the VLR table 332 and the IMSI lookup table 342 as valid while scanning through the VLR Table 322. All records that do not carry the marking are afterwards be deleted by the Garbage Collector.

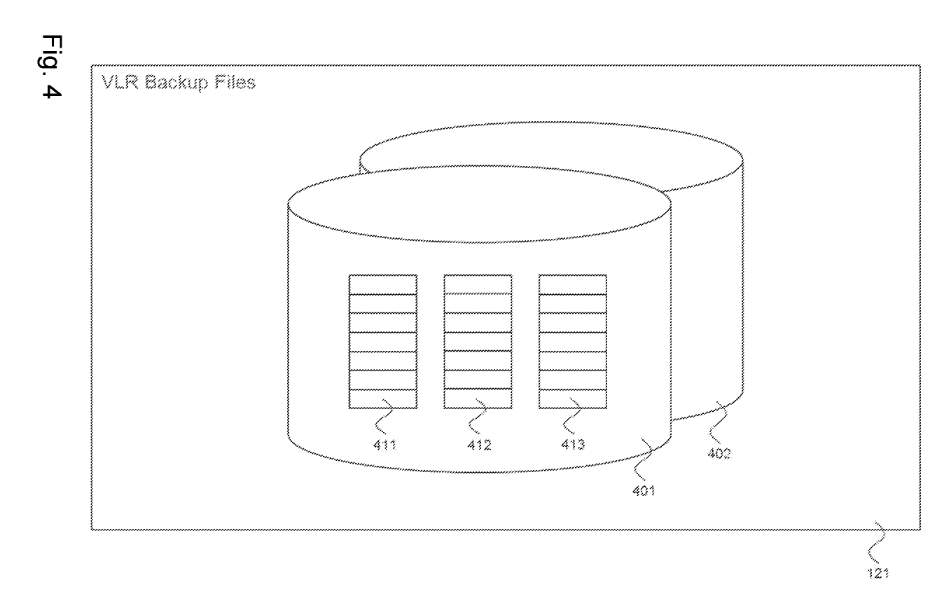

FIG. 4 shows backup files of a Shadow Cluster Visitor Location Register 131. An image of each table that is contained in the RAM of the Shadow Cluster-VLR 131 is stored in a corresponding file 411, 412, 413 within a file system that is physically located on at least two redundant hard drives 401 and 402 which are configured in a RAID or similar configuration that ensures retainability of the data in case of a single hard disk crash.

Write access to individual records within a file is done by using the same index that identifies the record within the RAM stored table on the Cluster-VLR. Read access to the data is done on per file basis, never on record level.

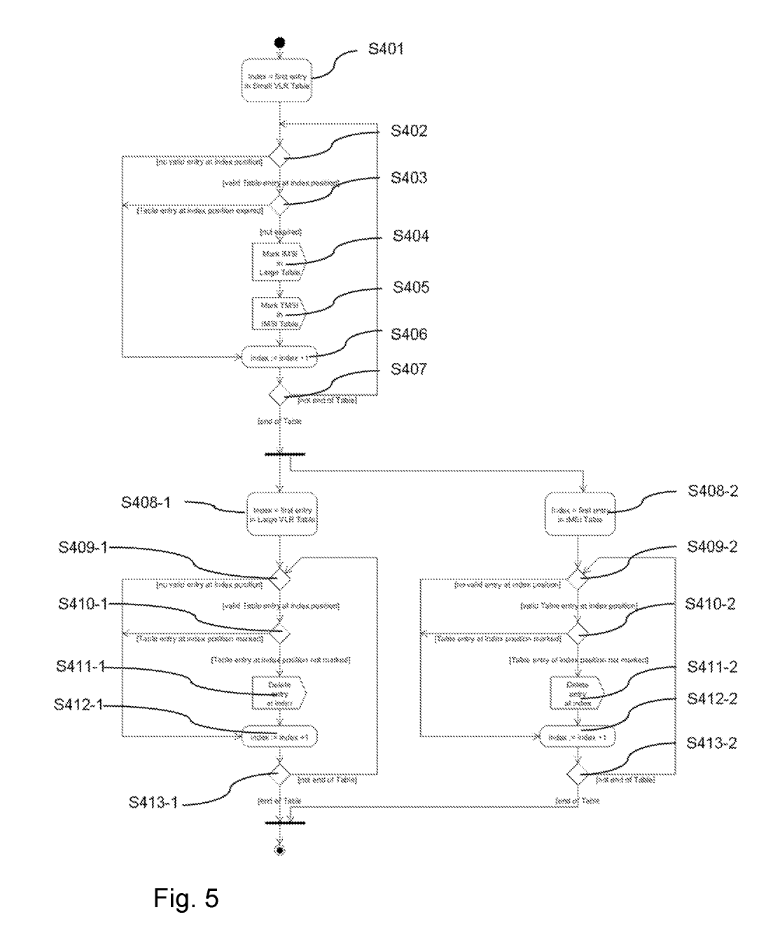

FIG. 5 shows an activity flow of the Garbage Collector, which should be triggered after every recovery of the Cluster VLR, and at an interval slightly larger than the interval of automatic deregistration that is configured in the node.

In step S401 the index is set to the first entry in the in the small VLR table 322, 222. In step S402 it is checked whether there is a valid table entry at the index position. If there is no valid table entry, step S406 is executed. If there is a valid table entry, it is checked in step S403, if the table entry at the index position is expired. If the table entry at the index position is expired, step S406 is executed. If the table entry at the index position is not expired, step S404 is executed. In step S404 the IMSI is marked in the large table. In following step S405 the TMSI is marked in the large table.

In step S406 the index is increased by one. In step S407 it is checked whether the end of the table has been reached. If the end of the table has not been reached, again step S402 is executed. If the end of the table has been reached step S408-1 and S408-2 are executed.

In step S408-1 the index is set to the first entry in the large VLR table. In step S409-1 it is checked whether there is a valid table entry at the index position. If there is no valid table entry, step S412-1 is executed. If there is a valid table entry, it is checked in step S410-1, if the Table Entry at the index position is marked. If the table entry the index position is marked, step 412-1 is executed. If the Table Entry at the index position is not marked, the entry at the index position is deleted in step S411-1.

In step S412-1 the index is increased by one. In step S413-1 it is checked whether the end of the table has been reached. If the end of the table has not been reached, again step S409-1 is executed. If the end of the table has been reached, it is terminated.

In step S408-2 the index is set to the first entry in the IMSI table. In step S409-2 it is checked whether there is a valid table entry at the index position. If there is no valid table entry, step S412-2 is executed. If there is a valid table entry, it is checked in step S410-2, if the Table Entry at the index position is marked. If the Table Entry at the index position is marked, step 412-2 is executed. If the Table Entry at the index position is not marked, the entry at the index position is deleted in step S411-2.

In step S412-2 the index is increased by one. In step S413-2 it is checked whether the end of the table has been reached. If the end of the table has not been reached, again step S409-2 is executed. If the end of the table has been reached, it is terminated.

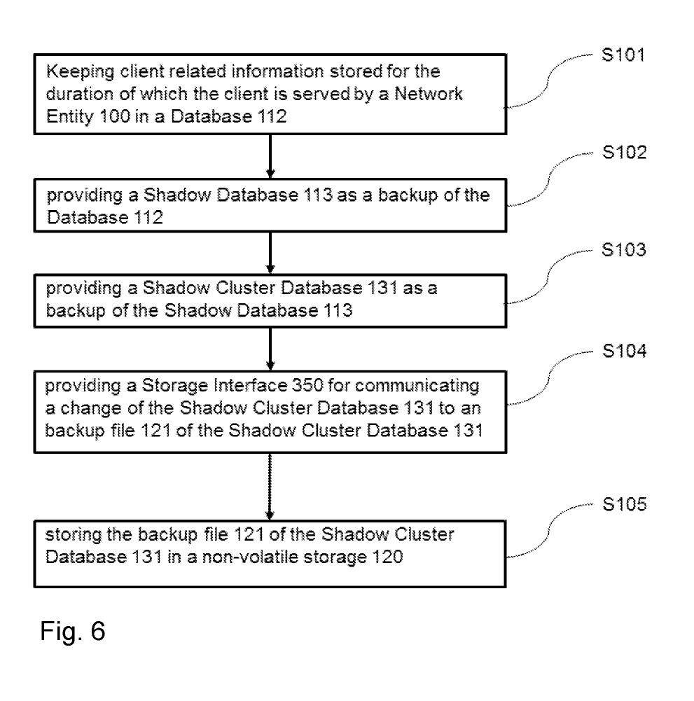

FIG. 6 shows a block diagram of a method for handling subscriber related information. Method comprises the step S101 of keeping subscriber related information stored for the duration of which the subscriber is served by a Network Entity 100 in a Visitor Location Register 112; the step S102 of providing a Shadow Visitor Location Register 113 as a backup of the Visitor Location Register 112; the step S103 of providing a Shadow Cluster Visitor Location Register 131 as a backup of the Shadow Visitor Location Register 113; the step S104 of providing a Storage Interface 350 for communicating a change of the Shadow Cluster Visitor Location Register 131 to at least one backup file 121 of the Shadow Cluster Visitor Location Register 131; and the step S105 of storing the backup file 121 of the Shadow Cluster Visitor Location Register 131 in a non-volatile storage 120.

Updating of VLR data during normal operation is performed as follows:

The traffic handling module 111 uses the internal VLR data base 112 to serve traffic handling needs. At every insertion, deletion or modification of VLR data, the VLR data base 112 passes update requests to the update handler 210 of the Shadow VLR. The Update Handler analyzes the data to be updated. Data that shall be stored in the Small VLR table is sent to the IMSI indexer 221, which finds the position of entry in the Small VLR table and inserts the data in the table 222. Data that shall be stored in the Large VLR table is sent to the IMSI indexer 231, which finds the position of entry in the Large VLR table and inserts the data in the table 232. If the TMSI is allocated or invalidated, the Update Handler sends it to the TMSI indexer 241, which finds the position of entry in the IMSI lookup table and inserts the data in the table 242. When a new TMSI is allocated, the old TMSI is invalided in the IMSI lookup table and the new TMSI needs to be added to the IMSI lookup table.

The Small VLR data tables 222 and 322 carry a timestamp in every record. It is generated by the Update Handler 210. The VLR 112 notifies the Update Handler at each radio contact with the mobile station, in order to keep the time stamps up to date.

After adding, modification or deletion of an entry in the Small VLR Table 222, the Cluster-VLR Updater 223 is informed and queues the update requests for sending via the Cluster VLR Interface 250 to the Shadow Cluster VLR 131. The same principle is followed by the Cluster VLR Updater 233 of the Large VLR Table 232 and the Cluster VLR Updater 243 of the IMSI lookup Table 242. A handshake between Cluster VLR Interface 250 and the Update Handler 310 makes sure that the Cluster VLR is not overloaded and that updates are queued until they can be served by the Cluster VLR. Said mechanism applies also in case of temporary outage of the Cluster VLR or when the Cluster VLR recovers the tables from disk.

When the Update Handler 310 of the Shadow Cluster-VLR 131 receives an update request, it analyzes the data to be updated. Data that shall be stored in the Small VLR table is sent to the IMSI indexer 321, which finds the position of entry in the Small VLR table and inserts the data in the table 322. Data that shall be stored in the Large VLR table is sent to the IMSI indexer 331, which finds the position of entry in the Large VLR table and inserts the data in the table 332. If the TMSI is allocated or invalidated, the Update Handler sends it to the TMSI indexer 341, which finds the position of entry in the IMSI lookup table and inserts the data in the table 342. When a new TMSI is allocated, the old TMSI needs to be invalided in the IMSI lookup table and the new TMSI needs to be added to the IMSI lookup table. So far, the handling is the same as on the Shadow VLR, except that the Cluster-VLR aggregates the data from all VLRs and the update Handler 310 does not generate time stamps.

After adding, modification or deletion of an entry in the Small VLR Table 322, the Disk Updater 323 is informed and queues the update requests for sending via the Storage Interface 350 to the Random Access Files 121. The same principle is followed by the Disk Updater 333 of the Large VLR Table 332 and the Disk Updater 343 of the IMSI lookup Table 342.

The files on the Storage Area Network 120 are exact images of the RAM stored tables on the Shadow Cluster-VLR. Therefore, records can be individually updated using the index positions identified by the Indexers 321, 331, 341 of the Shadow Cluster-VLR.

Restoration of VLR after recovery is performed as follows:

The VLR 113 loses the VLR data when the traffic handling blade 110 recovers from outage. Restoration of VLR after recovery is performed as needed on a per record basis. Requests that are received by the query handler 220 and have no matching entry in the respective table 222, 232, 242 are passed to the Cluster VLR fetcher 224, 234 or 244 which uses the Cluster-VLR interface 250 to obtain the data from the Cluster-VLR 131.

The Cluster-VLR Query Handler 320 serves the requests by sending it to the Indexer of the table that stores the respective type of data. Queries for data stored in the Small VLR table is sent to the IMSI indexer 321, which finds the position of entry in the Small VLR table and serves the request using table 322. Queries for data that is stored in the Large VLR table is sent to the IMSI indexer 331, which finds the position of entry in the Large VLR table and serves the request using table 332. Queries for translation from TMSI to IMSI are sent to TMSI indexer 341, which finds the position of entry in the IMSI lookup table and serves the request using table 342. By means of the described procedure, the Shadow VLR will regenerate itself during traffic handling over a period of time that will last as long as the duration of periodic location update time in the network.

Requests that are received by the query handler 320 and have no matching entry in the respective table 322, 332, 342 are rejected. No attempt is made to read the data from disk. Instead, the query handler 320 sends a negative result back to the Shadow VLR 113, which passes it through the VLR 112 to the traffic handling module 111 and the subscriber will eventually be treated as unknown by the MSC.

Resolving double VLR registration after recovery is performed as follows:

During outage of the VM/Blade 110, mobile stations that have been served by it may move to a different MSC service area. When registering a different service MSC, HLR will send a deregistration message to the previously serving MSC. If that MSC is not reachable but keeps the VLR data at recovery, then two MSC will have the user registered in their VLR. Two scenarios need to be considered:

If the user stays in the service area of the other MSC, then terminating calls are routed to the other MSC. No side effects will occur. The obsolete VLR record in the recovered MSC will eventually be removed by the automatic deregistration function and deletion of the respective VLR record will be cascaded down through the Shadow VLR, the Shadow Cluster VLR to the Storage files

If the user returns to the originally serving MSC, that one may serve the subscriber without contacting HLR and terminating calls would get lost because the HLR would still direct them to the other MSC. A new handling is needed as part of the proposed solution, as described below.

At the first network interaction of every subscriber, Traffic handling module 111 of an MSC that recovers, sends Update Location message to the HLR. This can be done during the ongoing call and does not delay call setup. By doing so, a potential double registration will be eliminated by the HLR when it sends Cancel Location message to the other MSC that has the subscriber registered.

Restoration of Cluster-VLR after recovery is performed as follows:

When the Shadow-Cluster VLR loses the VLR data stored in RAM, the Table Recoverer units 325, 335, 345 read the entire data set from the files 411, 412, 413 stored on the storage area network 120.

During the recovery of the data from disk, the VLR records that have been transferred can already be used to serve requests received by the query handler 320.

While reading from file, the update handler 310 must not accept changes to table entries that are not yet read from disk. This is easiest achieved by means of back-pressure through flow-control with the Cluster VLR updaters 223, 233, 243 of the Blade VLRs. Needed updates will be kept in the queues on the Blade VLRs until table recovery from disk is completed.

Garbage Collection is performed as follows:

It may happen that a subscriber de-registration is not received from the HLR because the traffic handling blade was unavailable or due to a disturbance in the signaling connection between MSC and HLR. Over time, this will generate stale entries in the Cluster Shadow VLR tables.

As long as the traffic handling blade 110 does not experience loss of RAM contents, the regular mechanism of automatic deregistration after a certain time of subscriber inactivity, which delete the subscriber from the VLR 112, will also trigger deletion of the subscriber related data from the tables in the Shadow VLR 113 and the Shadow Cluster-VLR 131.

If the traffic handling blade 110 has lost the VLR data, then the respective VLR data is still present in the Cluster VLR and the mirrored tables filed on disk. To address the problem of stale table entries, the small table in the Cluster-VLR has a Garbage Collector 360 connected, which checks in regular intervals for table entries that have expired time stamps and removes them from the table. Any change within a table is mirrored by the respective Disk Updater to the file on disk. The expiration threshold should be set similar to the automatic deregistration time value, which is larger than the periodic location update timer value in the network.

Outages of the Shadow Cluster-VLR during table write operations can lead to inconsistencies in the table that are not detected by the procedure described above. Therefore, at the first scanning round after such outage, the Garbage Collector additionally checks if the Large VLR table and the IMSI lookup table have corresponding entries for each entry in the Small VLR table. Such entries are marked as valid and the remaining records are afterwards removed by the Garbage Collector.

In case of outages of 110 entities or when scaling in or scaling out (adding or removing 110 entities) then the subscriber data can be moved between the 112 and 113 databases of the different 110 entities.

Recovery of VLR data used by traffic handling blades is performed from an in-memory database on a separate blade, satisfying real-time requirements. An up-to-date copy of the in-memory database is kept on disk all the time. In the event of memory loss of the database server, recovery of the entire database is done at once from disk.

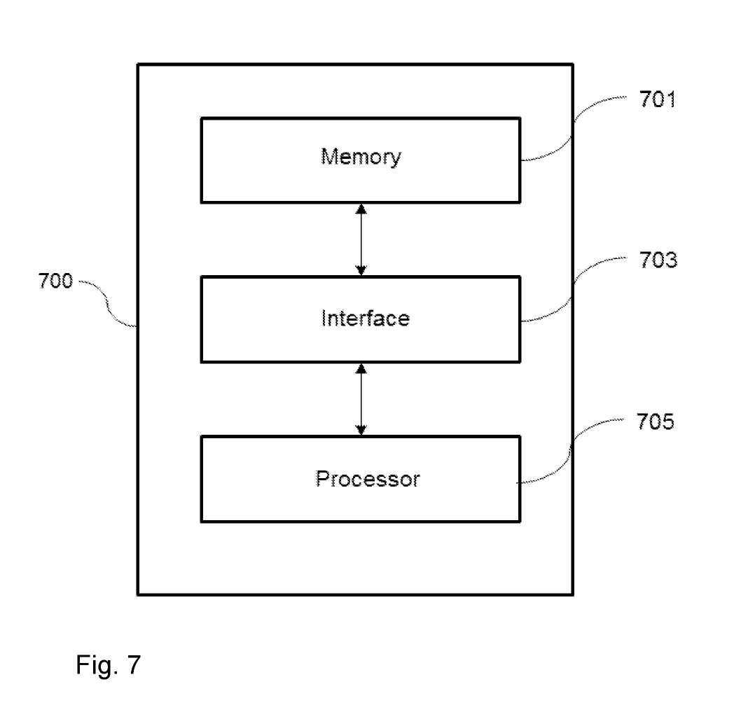

FIG. 7 shows a digital computer 700 as a Network Entity 100 or Execution entity 110. The computer 700 can comprise a computer program product that is directly loadable into the internal memory 701 of the digital computer 700, comprising software code portions for performing any of the aforementioned method steps when said product is run on the computer 700.

The computer 700 is a general-purpose device that can be programmed to carry out a set of arithmetic or logical operations automatically on the basis of software code portions. The computer 700 comprises the internal memory 701, such like a random access memory chip, that is coupled by an interface 703, like an IO bus, with a processor 705. The processor 705 is the electronic circuitry within the computer 700 that carries out the instructions of the software code portions by performing the basic arithmetic, logical, control and input/output (I/O) operations specified by the instructions. To this end the processor 705 accesses the software code portions that are stored in the internal memory 701.

The Network Entity, the Execution Entities and the method are optimized to keep the processing and internal communication load low during normal operation, while allowing for real-time access to VLR data in recovery scenarios. They are compatible with scaling of the virtualized application, i.e. recovery is still possible if the number of virtual blades changes. During normal operation, call set up time is not delayed. Recovery is performed from in-memory database, satisfying real-time requirements The Network Entity, the Execution Entities and the method can be easily integrated into existing system architectures and performance.

Redundancy of data is established asynchronously to traffic handling. Transactions that are “in flight” between the components when a fault occurs cannot get lost. For such small number of users, these data can be retrieved from HLR and global paging can be performed without risk for overload of HLR or radio network. VLR data inconsistencies between different storage locations within the MSC node, as may be created due to outages of system components, are automatically detected and resolved.

For a non-pooled MSC, the problem is eliminated that the first mobile originating transaction fails and the IMSI is exposed on the radio interface. The subscriber is reachable for terminating transactions without the need for prior originating transaction.

For an MSC in pool, the need for “enhanced mobile terminating call handling” (eMTCH) is eliminated, which stores a backup of some VLR data in an affiliated MSC within the same pool. Other than eMTCH, the invention not only allows mobile terminating transactions to be successful but also the mobile originating transaction to succeed if it is the first transaction after the outage. It works also for non-pooled MSC and it does not increase the duration of the first call set up after the outage.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation.

The invention is not limited to the examples of embodiments described above and shown in the drawings, but may be freely varied within the scope of the appended claims.

| Abbreviation | Explanation |
|---|---|
| eMTCH | Enhanced Mobile Terminating Call Handling |
| ETSI | European Telecommunications Standards Institute |
| HLR | Home Location Register |
| IMSI | International Mobile Subscriber Identity |
| MSC | Mobile Switching Center |
| RAID | Redundant Array of Independent Disks |
| RAM | Random Access Memory |
| SAN | Storage Area Network |
| TMSI | Temporary Mobile Subscriber Identity |
| VLR | Visitor Location Register |
| VNF | Virtualized Network Function |

1. Network Entity, comprising:
a processor; and
a memory coupled with the processor, wherein the memory contains instructions executable by said processor whereby said Network Entity is operative to,
keep client related information stored for the duration of which the client is served by the Network Entity in a Database;
provide a Shadow Database as a backup of the Database;
provide a Shadow Cluster Database as a backup of the Shadow Database;
communicate a change of the Shadow Cluster Database through a Storage Interface to a backup file of the Shadow Cluster Database; and
store the backup file of the Shadow Cluster Database in a non-volatile storage.

2. Network Entity according to claim 1, wherein the Database and the Shadow Database are provided by a first virtual machine or first blade unit and the Shadow Cluster Database and the Storage Interface are provided by a second virtual machine or blade unit.

3. (canceled)

4. Network Entity according to claim 1, wherein the database and the shadow database are combined in one database.

5. Network Entity according to claim 1, wherein the Shadow Database comprises a first table indexed on the basis of a client identity to store information that is frequently updated and a second table indexed on the basis of a client identity to store information that is less frequently updated,

6. Network Entity according to claim 5, wherein the Shadow Database comprises a third table to store mapping information between the International Mobile Subscriber Identity and an temporary identity of mobile subscriber equipment.

7. Network Entity according to claim 5, wherein at least one of the first, second, and third table comprises a cluster database fetcher associated to it to recover the content of the respective table from the Shadow Cluster Database.

8. Network Entity according to claim 1, wherein the Shadow Cluster Database comprises a first table indexed on the basis of a client identity to store information that is frequently updated, a second table indexed on the basis of a client identity to store information that is less frequently updated, and

9. Network Entity according to claim 8, wherein the Shadow Cluster Database comprises a third table to store mapping information between the International Mobile Subscriber Identity and a temporary identity of mobile subscriber equipment.

10. Network Entity according to claim 7, wherein at least one of the first, second, and third table comprises a Storage Fetcher associated to it to recover the content of the respective table from the backup file.

11. Network Entity according to claim 5, wherein the client entity comprises an International Mobile Subscriber Identity.

12. Network Entity according to claim 5, wherein the information that is frequently updated comprises information regarding a mobility related information and the information that is less frequently updated comprises subscription related information.

13.-14. (canceled)

14. Network Entity according to claim 1, wherein the Network Entity comprises a Mobile Switching Center Node, a Serving General Packet Radio Service Support Node or a Mobility Management Entity or a different network entity with mobility management functionality.

15. Network Entity according to claim 1, wherein the Shadow Cluster Database comprises a superset of a plurality of Shadow Databases.

16. (canceled)

17. Execution Entity for deployment in a Network Entity, comprising:
a processor; and
a memory coupled with the processor, wherein the memory contains instructions executable by said processor whereby said Execution Entity is operative to,
keep client related information stored for the duration of which the client is served by the Network Entity in a Database;
wherein the Database comprises a first table indexed on the basis of a client Identity to store information that is frequently updated and a second table indexed on the basis of an client Identity to store information that is less frequently updated.

18. Execution Entity for deployment in a Network Entity, comprising:
a processor; and
a memory coupled with the processor, wherein the memory contains instructions executable by said processor whereby said Execution Entity is operative to,
communicate with a Shadow Database through an interface;
provide a Shadow Cluster Database as a backup of the Shadow Database;
communicate a change of the Shadow Cluster Database through a Storage Interface to a backup file of the Shadow Cluster Database.

19. Execution Entity according to claim 17 wherein the Execution Entity is a blade unit or a virtual machine.

20. Method for handling client related information, comprising the steps:
keeping client related information stored for the duration of which the client is served by a Network Entity in a Database;
providing a Shadow Database as a backup of the Database;
providing a Shadow Cluster Database as a backup of the Shadow Database;
communicating a change of the Shadow Cluster Database through a Storage Interface to a backup file of the Shadow Cluster Database; and
storing the backup file of the Shadow Cluster Database in a non-volatile storage.

21. (canceled)

22. Method according to claim 20, wherein the client related information of the Shadow Database or the Shadow Cluster Database is stored in a first table to store information that is frequently updated, a second table to store information that is less frequently updated, and a third table to store mapping information.

23. Method according to claim 22, wherein the Shadow Cluster Database is checked in regular intervals for table entries that have expired time stamps and table entries that have expired time stamps are removed from the corresponding table.

24. Method according to claim 22, wherein it is checked in regular intervals for inconsistencies between the corresponding tables.

25. (canceled)

26. A computer program product comprising a computer readable storage medium having computer readable program code embodied in the computer readable storage medium, the computer readable program code being configured to perform operations according to claim 20.
